(19) United States
(12) Patent Application Publication
(10) Pub. No.: US 2018/0232529 A1
(43) Pub. Date: Aug. 16, 2018

(54) CLIENT-SIDE EXPOSURE CONTROL

(71) Applicant: Microsoft Technology Licensing, LLC, Redmond, WA (US)

(72) Inventors: Khalid Mahmood, Redmond, WA (US); Marina Veen, Seattle, WA (US); Krishnan Thazhathekalam, Bellevue, WA (US); Chaitanya Gogineni, Redmond, WA (US); Abhishek Agarwal, Hyderabad (IN)

(21) Appl. No.: 15/433,516

(22) Filed: Feb. 15, 2017

(51) Int. Cl. G06F 21/62; H04L 9/06; G06F 21/12

(52) U.S. Cl. CPC G06F 21/629; G06F 21/121; H04L 9/0643

(57) ABSTRACT

Systems and methods for controlling use of a software feature. One system includes a client device having an interface for receiving a feature control filter associated with the software feature from an external source and an electronic processor. The electronic processor executes the feature control filter to detect a current value of at least one run-time parameter of the client device, and compares the current value of the at least one run-time parameter of the client device to a predetermined value of the at least one run-time parameter defined for the software feature. When the current value satisfies the predetermined value, the electronic processor enables the software feature on the client device. When the current value does not satisfy the predetermined value, the electronic processor does not enable the software feature on the client device.

### FIELD

Embodiments described herein relate to controlling use of software features on a client device based on the run-time environment of the client device.

### SUMMARY

Software flighting may be used to release a new software feature to a set of client devices. For example, a cloud service may be used to provide flight information to a set of client devices that defines what software features to enable on what client devices. Accordingly, the cloud service provides server-side exposure control of new software features. Although this configuration allows the cloud service to centrally manage software flights, when the cloud service is unavailable, the client device may not be able to use available software features.

Accordingly, embodiments described herein provide client-side exposure control where a client device determines what software features to enable independent of flight information from a cloud service. In some embodiments, the client device executes code embedded in the software feature to detect the current value of one or more run-time parameters of the client device and identify whether the software feature should be enabled for the client device based on the current values. For example, a software application associated with the software feature and executed by the client device may use an application programming interface (API) to safely and securely communicate with other software components on the client device, such as the operating system, to detect the current value of one or more run-time parameters of the client device. The run-time parameters may be an operating system (type and version), a hardware configuration, a software version or build, a platform, and the like. The client device then compares current values of the run-time parameters to predetermined values of the run-time parameters associated with the software feature to determine whether to enable the feature. Thus, a software developer can embed logic into distributed code that, when executed by a client device, allows the client device to locally determine whether to enable a particular software feature. Using this implementation allows a client device to perform software testing, configuration changes, version control, and the like without the need to communicate with external devices.

For example, one embodiment provides a system for controlling use of a software feature at a client device. The system includes the client device, which includes an interface for receiving a feature control filter associated with the software feature from an external source and an electronic processor. The electronic processor is configured to execute the feature control filter to detect a current value of at least one run-time parameter of the client device and compare the current value of the at least one run-time parameter of the client device to a predetermined value of the at least one run-time parameter defined for the software feature. When the current value of the at least one run-time parameter of the client device satisfies the predetermined value of the at least one run-time parameter defined for the software feature, the electronic processor is configured to enable the software feature on the client device. When the current value of the at least one run-time parameter of the client device does not satisfy the predetermined value of the at least one run-time parameter defined for the software feature, the electronic processor is configured not enable the software feature on the client device.

Another embodiment provides a method for controlling use of a software feature at a client device. The method includes receiving, at the client device, a feature control filter associated with the software feature, wherein the feature control filter is embedded in a software application associated with the software feature. The method also includes executing, with an electronic processor included in the client device, the feature control filter to detect a current value of at least one run-time parameter of the client device and compare the current value of the at least one run-time parameter of the client device to a predetermined value of the at least one run-time parameter defined for the software feature. The method also includes, when the current value of the at least one run-time parameter of the client device satisfies the predetermined value of the at least one run-time parameter defined for the software feature, enabling the software feature on the client device, and, when the current value of the at least one run-time parameter of the client device does not satisfy the predetermined value of the at least one run-time parameter defined for the software feature, not enabling the software feature on the client device.

Yet a further embodiment provides non-transitory computer-readable medium containing instructions, that when executed, perform a set of functions. The set of functions includes detecting a current value of at least one run-time parameter of a client device and comparing the current value of the at least one run-time parameter of the client device to a predetermined value of the at least one run-time parameter defined for a software feature. The set of functions also includes, when the current value of the at least one run-time parameter of the client device satisfies the predetermined value of the at least one run-time parameter defined for the software feature, enabling the software feature on the client device. In addition, the set of functions includes receiving a shutdown instruction including a unique flight number, determining whether the unique flight number is associated with the software feature using a hashing algorithm, and disabling the software feature on the client device when the unique flight number is associated with the software feature.

### BRIEF DESCRIPTION OF THE DRAWINGS

FIGS. 1 and 2 schematically illustrate systems for controlling use of software features.

FIG. 3 schematically illustrates a client device included in the system of FIG. 2.

FIG. 4 is a flow chart illustrating a method of controlling use of a software feature performed by the client device of FIG. 3.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not include a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As noted above, embodiments provide, among other things, systems and methods for controlling use of a software feature at a client device. As used in the present application, a software feature may include an entire software application or a particular feature accessible within a software application, such as particular functions or options. For example, for a word-processing software application, a software feature may include an advanced printing option, an icon for accessing a menu for editing a table of data, an add-on for performing advanced texting search functions, and the like. Also, it should be understood that, as used in the present application, a new software feature may include an entirely new feature or an update to an existing feature.

When a software developer creates code for a new software feature, the software developer may deploy the new software feature through a cloud service. The software developer (or a separate administrator associated with the cloud service) also provides one or more audience selections that define what client devices may use the new software feature. For example, when testing the new software feature, only certain client devices may be allowed to use the software feature to set a controlled audience for the initial test. The controlled audience may be set based on compatibility concerns, access control concerns, subscription levels, computing resource limitations, and the like. For example, the audience selections may specify that only client devices running a particular operating system or associated with a particular country, language, or platform may use the deployed software feature.

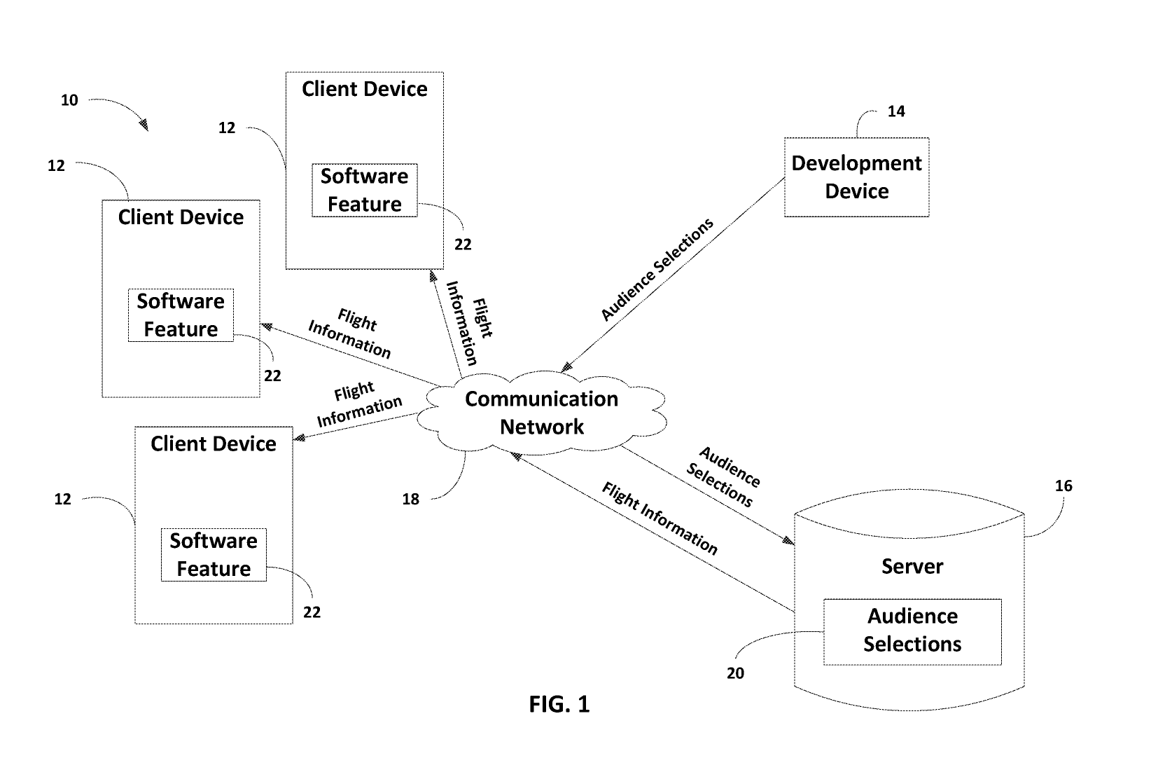

The cloud service may include one or more servers that communicate with one or more client devices over a communication network, such as the Internet. The servers communicate with the client device to provide flight information, which informs each client devices what software features may be enabled. The flight information is based on the audience selections for the software features. For example, FIG. 1 illustrates a system 10 for controlling use of software features. The system 10 includes a plurality of client devices 12, a development device 14, and a server 16 that communicate over a communication network 18. The software developer associated with a new software feature may use the development device 14 (for example, a laptop computer, desktop computer, tablet computer, smart phone, and the like) to communicate with the server 16 (provided as part of a cloud service for managing deployment of software) to provide audience selections 20. As described above, the audience selections 20 specify the client devices 12 that may use the software feature 22. The development device 14 may access one or more user interfaces provided by the server 16 that present a developer with various user-selections options for the audience selections 20.

The server 16 stores the audience selections 20 (and may also store the associated software feature) and uses the audience selections 20 to provide software flight information to the client devices 12. For example, the server 16 determines whether a particular client device 12 is included in the audience for the new software feature 22 based on the audience selections 20 and informs the client device 12 whether the client device 12 can enable the new software feature 22 through the flight information. The server 16 may provide the flight information in response to requests from particular client devices 12 or proactively based on known information regarding what client devices 12 are associated with the cloud service.

As noted above, when the server 16 (or the underlying cloud service) is unavailable (the server 16 is down for maintenance, the communication network 18 is unavailable, the client device 12 is offline, or the like), the client device 12 cannot receive flight information. Accordingly, in this situation, the client device 12 may not be able to use the software feature 22 even though the client device 12 is included in the audience for the software feature 22. Thus, a user of the client device 12 cannot use of the new software feature 22, which limits testing of the new software feature by targeted users.

To address these and other problems, embodiments described herein provide code to a client device associated with a software feature (for example, embedded into the software feature). Once a client device receives the code, the client device executes the code to independently determine whether to enable a software feature independent of any flight information received from server-side components (without having to interact with server-side components). Thus, a developer can rollout individual software features easily and efficiently. In some embodiments, client-side application programming interfaces (APIs) control expose of run-time parameters of the client device, which allows software features available on a client device to be configured independent of flight information from a cloud service.

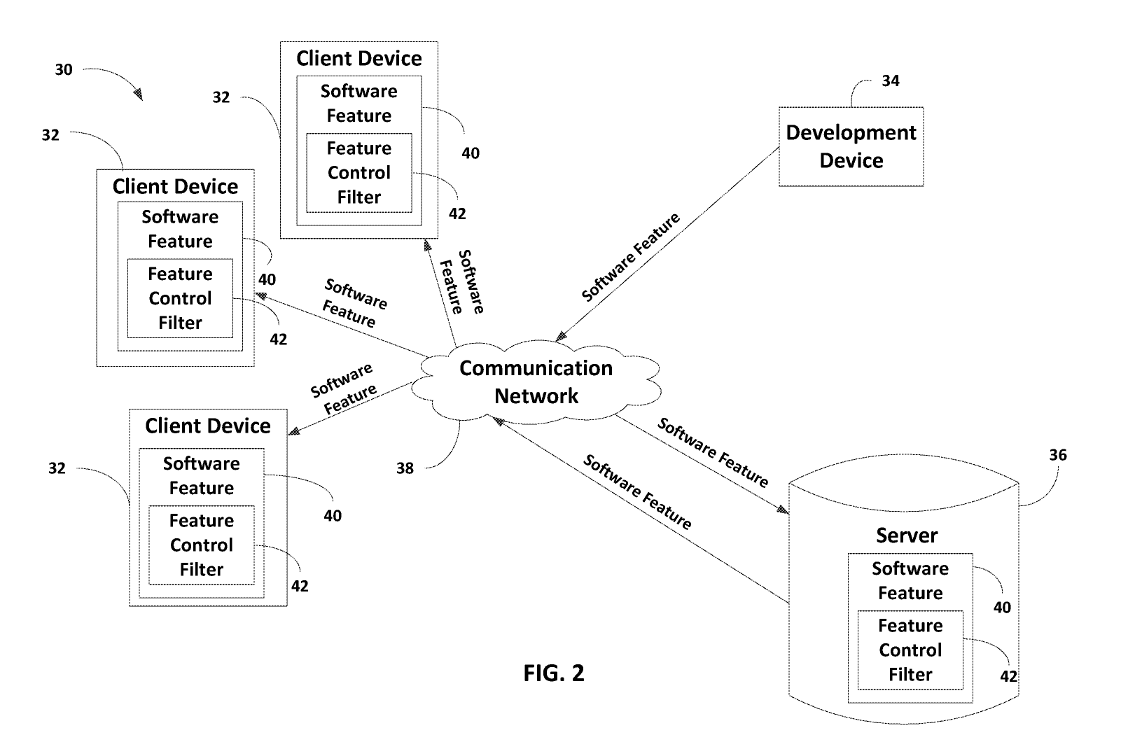

For example, FIG. 2 illustrates another system 30 for controlling use of software features. The system 30 includes a plurality of client devices 32, a development device 34, and a server 36 that communicate over a communication network 38. It should be understood that in some embodiments the system 30 may include fewer or additional components in various configuration. For example, three client devices 32 are illustrated in FIG. 2 as one example and more or fewer client devices 32 may be included in the system 30. Also, in some embodiments, the system 30 may include multiple servers that provide the functionality of the server 36 described herein in a distributed or cloud-based fashion.

The communication network 38 may be a wired network or a wireless network and may be implemented using a wide area network, such as the Internet, a local area network, such as Wi-Fi, or combinations or derivatives thereof. It should be understood that the client devices 32, the development device 34, and the server 36 may communicate over more than one communication network and different pairs of components may communicate over different networks. Also, in some embodiments, the client devices 32, the development device 34, or both may communicate with the server 36 over a dedicated connection rather than a communication network. Furthermore, in some embodiments, the client devices 32 may communicate with the development device 34 over a dedicated connection or a separate communication network than the communication network 38.

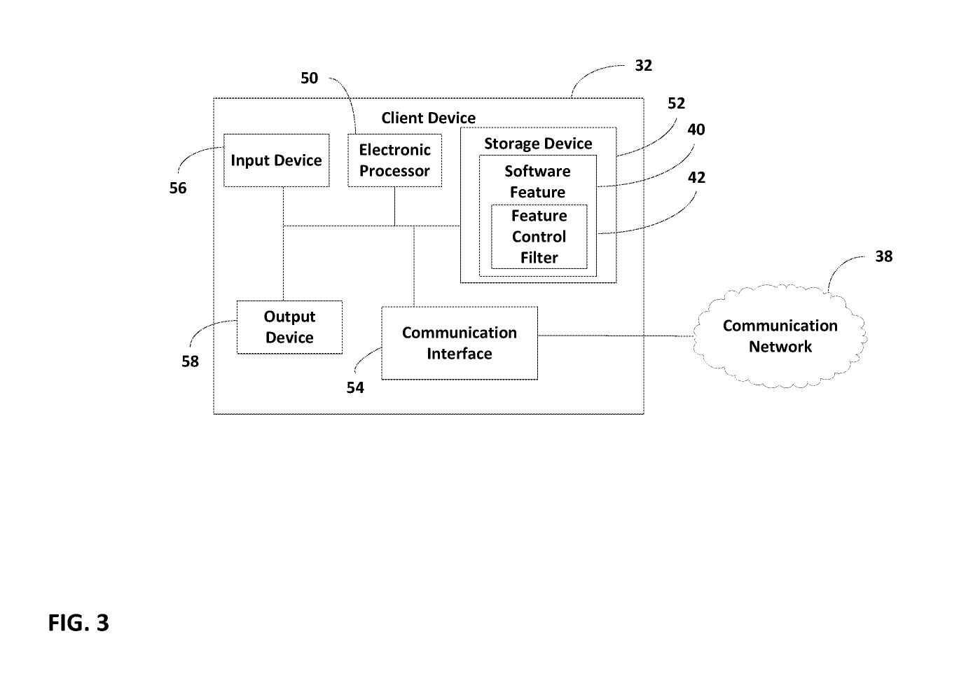

The development device 34 is a computing device, such as a laptop computer, a desktop computer, a tablet computer, a smart phone, or other device that executes on one or more software applications for developing and deploying software features. In some embodiments, the development device 14 includes similar components as a client device 32 as described below with respect to FIG. 3.

A developer uses the development device 34 to write code that, when executed by a client device 32, allows the client device 32 to detect a current value of one or more run-time parameters of the client device 32 and compare the current value of the run-time parameters to a predetermined value of the run-time parameters to determine whether to enable a particular software feature 40. In other words, the code written by the developer defines an audience for a particular software feature based on a set of predetermined values for one or more run-time parameters. When the current values of such real-time parameters of a client device 32 satisfy the predetermined values, the software feature is enabled for the client device 32. This code is referred to herein as a feature control filter 42. As described in more detail below, the feature control filter 42 may use one or more application programming interfaces (APIs) that allows the feature control filter 42 to safely and securely access current values of run-time parameters of a client device 32. For example, an API may provide a function that returns a Boolean value of TRUE or FALSE depending on whether the current value of a run-time parameter of the client device 32 satisfies a predetermined value of the run-time parameter (passed as input to the function). In addition or alternatively, an API may provide a function that returns the current value of one or more run-time parameters of the client device 32 for further processing. Accordingly, the code written by the developer may call one or more functions to determine whether a particular client device 32 is included in an audience defined for the software feature 40.

In some embodiments, as illustrated in FIG. 2, the developer embeds the feature control filter 42 in the code defining a software feature 40. However, it should be understood that feature control filter 42 may be provided separate from the software feature 40 or may be embedded in other software, such as a software application that the software feature 40 is accessible through. It should also be understood that, in some embodiments, a feature control filter 42 may be associated with multiple software features 40.

As illustrated in FIG. 2, the development device 34 provides the software feature 40 and the feature control filter 42 to the server 36. It should be understood that in some embodiments, in addition to or as an alternative to providing the software feature 40 and the feature control filter 42 to the server 36, the development device 34 may provide the software feature 40, the feature control filter 42, or both directly to one or more of the client devices 32. Also, when the feature control filter 42 is not embedded in the software feature 40, the development device 34 may provide the software feature 40 and the feature control filter 42 to different devices, including, for example, separate servers. Also, in some embodiments, the developer may define an audience for a software feature 40 through audience selections provided to the server 36 as described above with respect to FIG. 1, and the server 36 may be configured to automatically generate (and embed) the feature control filter 42.

The server 36 stores the software feature 40 and the feature control filter 42 (which may be embedded in the software feature 40) and provides the software feature 40 and the feature control filter 42 to the client devices 32. As noted above, in some embodiments, a client device 32 may receive a software feature 40 and an associated feature control filter 42 from difference devices (for example, two separate servers), the development device 34, or a combination thereof. As described in more detail below, each client device 32 executes the feature control filter 42 to determine whether to enable the software feature 40 on the client device 32.

Like the development device 34, each client device 32 may be a computing device, such as a laptop computer, desktop computer, tablet computer, smart phone, smart watch, and the like. For example, as illustrated in FIG. 3, each client device 32 may include an electronic processor 50 (for example, a microprocessor, application-specific integrated circuit (ASIC), or another suitable electronic device), a storage device 52 (for example, a non-transitory, computer-readable storage medium), and a communication interface 54, such as a transceiver, for communicating over the communication network 38 and, optionally, one or more additional communication networks or connections. As illustrated in FIG. 3, a client device 32 may also include one or more input devices 56, one or more output devices 58, or a combination thereof. The input device 56 may receive input from a user of the client device 32 and may be a keyboard, a mouse, a touchscreen, a touchpad, and the like. Similarly, the output device 58 may provide output to a user of the client device 32 and may be a display device, a touchscreen, and the like. It should be understood that a client device 32 may include additional components than those illustrated in FIG. 3 in various configurations and may perform additional functionality than the functionality described in the present application.

The electronic processor 50, the storage device 52, the communication interface 54, the input device 56, and the output device 58 included in a client device 32 communicate over one or more wired communication lines or buses or wirelessly. The storage device 52 stores software (instructions), including the software feature 40 and the associated feature control filter 42 (which may be embedded in the software feature 40). It should be understood that, in some embodiments, a client device 32 may include more than one storage device and the software feature 40 and the associated feature control filter 42 may be stored in separate storage devices. The electronic processor 50 is configured to retrieve software from the storage device 52 and execute, among other things, the software. As described in more detail below, the electronic processor 50 is configured to execute the feature control filter 42 to determine whether to enable the software feature 40.

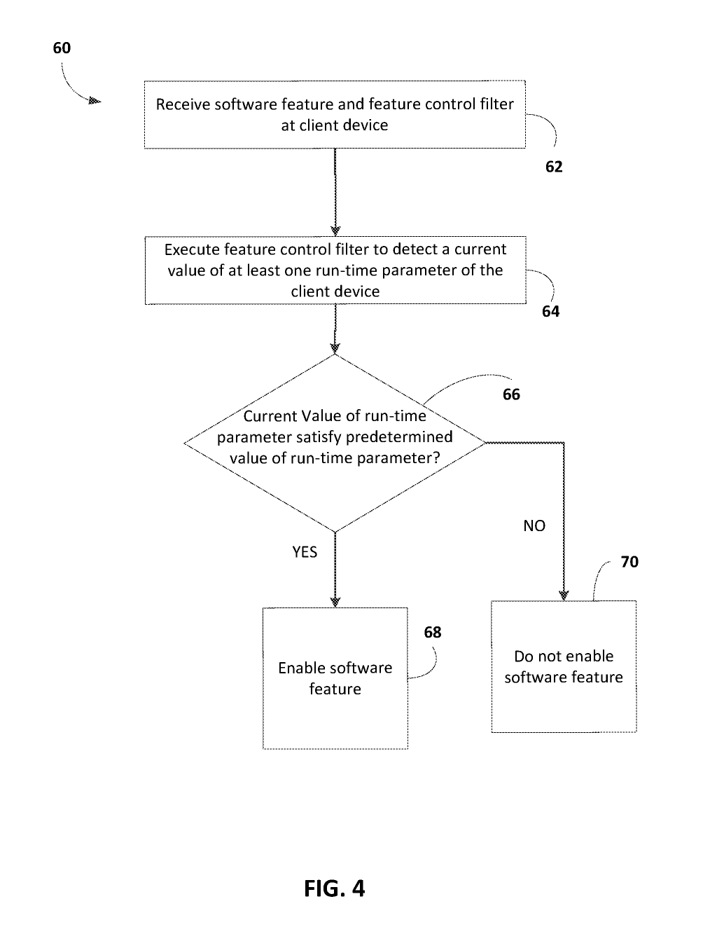

For example, FIG. 4 illustrates a method 60 performed by a client device 32 for controlling use of the software feature 40. As illustrated in FIG. 4, the method 60 includes receiving, at the client device 32, the software feature 40 and the associated feature control filter 42 from an external source (at block 62). As described above, the client device 32 may receive the software feature 40 and the associated feature control filter 42 from the server 36 through the communication interface 54. However, as also noted above, in other embodiments, the client device 32 may receive the software feature 40, the feature control filter 42, or both from other sources, including, for example, the development device 34, another client device 32, or another server. Furthermore, in some embodiments, the software feature 40, the feature control filter 42, or both may be copied to client device 32 from a portable storage device, such as a memory stick. As also noted above, in some embodiments, the feature control filter 42 is embedded in the software feature 40.

The method 60 also includes executing, with the electronic processor 50, the feature control filter 42 to detect a current value of at least one run-time parameter of the client device 32 (at block 64). The at least one run-time parameter may include a type or version of a software application (for example, an operating system) used by the client device 32; hardware available on the client device 32 (for example, whether the client device 32 includes a touchscreen or dual displays, an amount of available memory, and the like); a platform, architecture, or build associated with the client device 32 (for example, a 64-bit client or a 32-bit client, a ship build or a debug build, and the like); parameters of a user associated with the client device 32 (for example, a user name, a group name, an access level, a subscription level, a channel, and the like); a language used by the client device 32 (for example, English, Spanish, French, and the like); a country or region associated with a client device 32 (for example, United States, North America, and the like), and the like. In some embodiments, one or more of these parameters may be set through one or more user interfaces displayed by the client device 32. For example, the user interfaces may allow a user to specify their language, country, region, team, username, and the like.

As illustrated in FIG. 4, the method 60 also includes comparing the current value of at least one run-time parameter of the client device 32 to a predetermined value of the at least one run-time parameter (at block 66). When the current value of the at least one run-time parameter of the client device 32 satisfies the predetermined value of the at least one run-time parameter defined for the software feature 40, the software feature 40 is enabled at the client device 32 (at block 68). A current value may satisfy a predetermined value of a run-time parameter when the current value equals the predetermined value, is within a range or a list of predetermined values, differs by less than a predetermined amount from the predetermined value, or the like. In some embodiments, the software feature 40 is enabled by setting a flag or variable that, once set, allows the electronic processor 50 to execute the software feature 40. Alternatively, when the current value of the at least one run-time parameter of the client device 32 does not satisfy the predetermined value of the at least one run-time parameter defined for the software feature 40, the software feature is not enabled (at block 70).

As noted above, the feature control filter 42 may use an API to safely and securely detect and compare run-time parameters of the client device 32. For example, an API may allow the feature control filter 42 to communicate with an operating system executed by the client device 32 and, in particular, may provide a function that returns a Boolean value of TRUE or FALSE depending on whether the current value of one or more run-time parameters of a client device 32 satisfy the predetermined value of the one or more run-time parameters (passed as input to the function). Accordingly, the code written by the developer may call these functions to detect current values of run-time parameters, compare the current values to predetermined values, or a combination thereof.

In some embodiments, the functions available through the API allow the current values of one or more run-time parameters of the client device 32 to be considered independently or in combination. For example, through an API, the feature control filter 42 may detect whether the client device 32 includes dual displays and uses the English language. The functions provided by the API may perform the comparison and return a TRUE or a FALSE accordingly, which instructs the feature control filter 42 whether to enable the software feature 40. In this example, when the client device 32 includes dual displays and uses the English language, a particular software feature that requires dual screens and is currently only offered in English may be enabled on the client device 32. Similarly, the feature control filter 42 may detect whether the version of the operating system used by the client device 32 is equal to a predetermined version number, exceeds a predetermined version number, is within a predetermined range of version numbers, or a combination thereof to determine whether to enable the software feature 40. It should be understood that, in addition or alternatively, an API may provide functions that return the current value of one or more run-time parameters. For example, the API may provide a function that returns a current version of an operating system used by the client device 32, such as “Windows Version 11.1.” It should also be understood that the feature control filter 42 may call one or more functions through one or more different APIs to detect current values of run-time parameters, compare current values to predetermined values of run-time parameters, or both.

Once enabled, a client device 32 may use the software feature 40 and, optionally, may store and report testing results to the server 36, the development device 34, or other devices. In some embodiments, once enabled, a software feature 40 may remain enabled until the server 36 or the development device 34 instructs a client device to disable the software feature 40. In other embodiments, a software feature 40 may be associated with an expiration time after which the software feature 40 is automatically disabled (for example, when a software feature 40 is provided as part of a limited software trial). Also, in some embodiments, the client device 32 may be configured to determine whether to disable a previously-enabled software feature 40 by detecting and comparing current values of run-time parameters of the client device 32 as described above for enabling the software feature 40. For example, as the values of run-time parameters of a client device 32 change, the client device 32 may automatically disable software features 40 when the current values of such run-time parameters no longer satisfy the predetermined values defined for the software feature 40.

When a particular software feature needs to shutdown, such as in an emergency or when the software feature 40 is faulty or unstable), the server 36 may transmit instructions to the client devices 32 to shut down the feature. In some embodiments, each software feature may be associated with a software flight, which may include a single software feature or a set of software features. For example, when the server 36 provides flight information, the server 36 assigning a unique flight number to each software flight and, optionally, may track what client devices 32 are associated with flight. Accordingly, when a particular features needs to be shut down, the server 36 transmits a shutdown instruction to the client devices 32 that includes the previously-assigned unique flight number associated with the feature to disable. It should be understood that, as used in the present application, flight number may include numbers, characters, symbols, or a combination thereof and is not limited to just a numerical value.

However, when the server 36 does not provide flight information to the client devices 32 as described above, the server 36 may not assign unique flight numbers as described above, which makes it difficult for the server 36 to instruct client devices 32 to disable particular software features. Furthermore, even when a developer defines an identifier for a particular flight, such as providing a flight or feature name, there is nothing preventing another developer from defining an identical identifier for a different flight (or the same developer accidentally defining the same identifier for two different flights).

Accordingly, to address this and other concerns, a developer may be able to reserve a unique flight number without accessing the server 36. For example, the developer may select a flight identifier, such as a feature name and may provide this flight identifier to the client devices 32, such as within the feature control filter 42. When the feature needs to be shut down by the server 36, the server 36 generates a hash of the flight identifier assigned by the developer using a hashing algorithm. The hashing algorithm can provide a mapping between a flight identifier (a feature name) and a unique flight number. In particular, the hashing algorithm may take a variable length input and provide a fixed length output, which each input is mapped to a distinct output. In some embodiments, the hashing algorithm is a Fowler-Noll-Vo (FNV) hashing algorithm but other types of hashing algorithms may be used.

After generating the unique flight number for the flight identifier using the hashing algorithm, the server 36 provides the unique flight number to the client devices 32 as part of a shutdown instruction. The client devices 32 use the provided unique flight number and the hashing algorithm (which may also be provided to the client devices 32 by the server 36) to identify what software features 40 to disable. For example, the client device 32 may use the hashing algorithm to generate a unique flight number for each flight identifier the client device 32 is associated with (for each software feature enabled on the client device 32) and compare the generated unique flight numbers with the received flight number included in the shutdown instruction. When the client device 32 identifies a match (for example, an identical match) between a generated unique flight number and the received unique flight number, the client device 32 disables the software feature (or features) associated with the flight identifier that resulted in the matching unique flight number. Thus, using the hashing algorithm allows a developer to indirectly reserve a unique flight number without having to interact with the server 36 or other server-side or service-side devices or portals. It should be understood that, in some embodiments, the hashing algorithm is a two-way hash that allows the client device 32 to directly determine, from the unique flight number received from the server 36, the corresponding flight identifier.

As described above, the feature control filter 42 allows a client device 32 to locally determine whether to enable a particular software feature independent of any flight information received from the server 36 or other external sources. Similarly, in some embodiments, the feature control filter 42 allows a developer to implement and configure flights directly without having to rely on the server 36 to provide flight information. Accordingly, even if the developer uses the server 36 to initially distribute software features, record testing results, shutdown particular software flights, or a combination thereof, the developer may not rely on the server 36 to initially provide flight information to client devices 32.

Although the above systems and methods are described with reference to testing new software features, it should be understood that the systems and methods may be used to control use of particular software features for other purposes. For example, a software provider may create different versions of software for different types of client devices. In particular, a software provider may create one version of software for client devices using a first version of an operating system and may create a second version of software for client devices using a second version of the operating system. Creating and maintaining multiple different versions of software, however, creates inefficiencies and complexity. Furthermore, when the wrong version of software is used with a particular client device, the software may not work or cause other errors. Furthermore, if a client device is updated with, for example, a new version of an operating system, the client device 32 may need to acquire completely new versions of previously-installed software. Accordingly, the methods and systems described above may be used to provide common software features (and software applications) to different types of client devices, wherein the client devices can decide whether to enable particular software features or applications as described above. Similarly, when different types of client devices need different versions of a common software feature, one piece of software can be created that includes all of the different versions and each client device can determine what applicable version should be enabled as described above. For example, the specific version of the operating system used by a client device may control how external devices, network communication, and security operate on a client device. Therefore, software features that use Bluetooth connected devices or 5G wireless communication or enforce higher levels of security may be enabled on client devices that use a particular version of an operating system. As another example, the client device may have additional memory installed or may have a touchscreen, which may dictate what software features should be enabled for the client device. The version of a software application used by the client device may similarly regulate what software features should be enabled or disabled. For example, a premium version of a software application may provide advanced features while a basic version may not. Accordingly, in each of these examples, a client device may use the run-time environment of the client device to locally control what software features stored on the client device are enabled (or disabled). Furthermore, as the values of these run-time parameters change, the client device can be configured to enable (and disable) software features accordingly to keep its software updated and compatible.

Various features and advantages of some embodiments are set forth in the following claims.

What is claimed is:

1. A system for controlling use of a software feature on a client device, the system comprising:
the client device including
an interface for receiving a feature control filter associated with the software feature from an external source, and
an electronic processor configured to execute the feature control filter to
detect a current value of at least one run-time parameter of the client device,
compare the current value of the at least one run-time parameter of the client device to a predetermined value of the at least one run-time parameter defined for the software feature,
when the current value of the at least one run-time parameter of the client device satisfies the predetermined value of the at least one run-time parameter defined for the software feature, enable the software feature on the client device, and
when the current value of the at least one run-time parameter of the client device does not satisfy the predetermined value of the at least one run-time parameter defined for the software feature, not enable the software feature on the client device.

2. The system of claim 1, wherein the feature control filter is embedded in the software feature.

3. The system of claim 1, wherein the interface is further configured to receive the software feature.

4. The system of claim 1, wherein the electronic processor is configured to detect the current value of the at least one run-time parameter of the client device through an application programming interface.

5. The system of claim 4, wherein the application programming interface provides a function that returns a Boolean value and takes the predetermined value of the at least one run-time parameter as input, wherein the function returns a TRUE value when the current value of the at least one run-time parameter satisfies the predetermined value of the at least one run-time parameter and returns a FALSE value when the current value of the at least one run-time parameter does not satisfy the predetermined value of the at least one run-time parameter.

6. The system of claim 1, wherein the at least one run-time parameter of the client device includes at least one selected from a group consisting of a type of operating system used by the client device, a software application version used by the client device, a hardware configuration of the client device, a platform of the client device, an architecture of the client device, and a build of the client device.

7. The system of claim 1, wherein the at least one run-time parameter of the client device includes a parameter of a user of the client device, wherein the parameter of the user of the client device includes at least one selected from a group consisting of a user name, a group name, an access level, a subscription level, and a channel.

8. The system of claim 1, wherein the at least one run-time parameter of the client device includes at least one selected from a group consisting of a language associated with the client device, a country associated with the client device, and a region associated with the client device.

9. The system of claim 1, wherein the software feature is associated with a flight identifier and wherein the electronic processor is further configured to receive a shutdown instruction including a unique flight number, generate a hash of the flight identifier using a hashing algorithm, compare the hash of the flight identifier and the unique flight number, and disable the software feature when the hash of the flight identifier matches the unique flight number.

10. A method for controlling use of a software feature on a client device, the method comprising:
receiving, at the client device, a feature control filter associated with the software feature, wherein the feature control filter is embedded in a software application associated with the software feature;
executing, with an electronic processor included in the client device, the feature control filter to
detect a current value of at least one run-time parameter of the client device,
compare the current value of the at least one run-time parameter of the client device to a predetermined value of the at least one run-time parameter defined for the software feature,
when the current value of the at least one run-time parameter of the client device satisfies the predetermined value of the at least one run-time parameter defined for the software feature, enable the software feature on the client device, and
when the current value of the at least one run-time parameter of the client device does not satisfy the predetermined value of the at least one run-time parameter defined for the software feature, not enable the software feature on the client device.

11. The method of claim 10, wherein detecting the current value of the at least one run-time parameter of the client device includes detecting the current value of the at least one run-time parameter of the client device through an application programming interface.

12. The method of claim 11, wherein detecting the current value of the at least one run-time parameter of the client device through the application programming interface includes calling a function that returns a Boolean value and takes the predetermined value of the at least one run-time parameter as input, wherein the function returns a TRUE value when the current value of the at least one run-time parameter satisfies the predetermined value of the at least one run-time parameter and returns a FALSE value when the current value of the at least one run-time parameter does not satisfy the predetermined value of the at least one run-time parameter.

13. The method of claim 10, wherein detecting the current value of the at least one run-time parameter includes detecting the current value of at least one selected from a group consisting of a type of operating system used by the client device, a software application version used by the client device, a hardware configuration of the client device, a platform of the client device, an architecture of the client device, and a build of the client device.

14. The method of claim 10, wherein detecting the current value of the at least one run-time parameter includes detecting the current value of a user parameter including at least one selected from a group consisting of a user name, a group name, an access level, a subscription level, and a channel.

15. The method of claim 10, wherein detecting the current value of the at least one run-time parameter includes detecting the current value of at least one selected from a group consisting of a language associated with the client device, a country associated with the client device, and a region associated with the client device.

16. The method of claim 10, further comprising:
receiving, at the client device, a shutdown instruction including a unique flight number;
generating, with the electronic processor included in the client device, a hash of a flight identifier associated with the software feature using a hashing algorithm;
comparing, with the electronic processor included in the client device, the hash of the flight identifier and the unique flight number; and
disabling, with the electronic processor included in the client device, the software feature when the hash of the flight identifier matches the unique flight number.

17. Non-transitory computer-readable medium storing instructions, that when executed, perform a set of functions, the set of functions comprising:
detecting a current value of at least one run-time parameter of a client device;
comparing the current value of the at least one run-time parameter of the client device to a predetermined value of the at least one run-time parameter defined for a software feature;
when the current value of the at least one run-time parameter of the client device satisfies the predetermined value of the at least one run-time parameter defined for the software feature, enabling the software feature on the client device;
receiving a shutdown instruction including a unique flight number;
determining whether the unique flight number is associated with the software feature using a hashing algorithm; and
disabling the software feature on the client device when the unique flight number is associated with the software feature.

18. The non-transitory, computer-readable medium of claim 17, wherein the hashing algorithm includes a Fowler-Noll-Vo hashing algorithm.

19. The non-transitory, computer-readable medium of claim 17, wherein determining whether the unique flight number is associated with the software feature using the hashing algorithm includes using the hashing algorithm to generate a second unique flight number based on an identifier associated with the software feature and comparing the second unique flight number and the first unique flight number and wherein disabling the software feature when the first unique flight number is associated with the software feature includes disabling the software feature when the first unique flight number matches the second unique flight number.

20. The non-transitory, computer-readable medium of claim 17, wherein the hashing algorithm includes a two-way hashing algorithm.
